(19) United States
(12) Patent Application Publication
(10) Pub. No.: US 2008/0297405 A1
(43) Pub. Date: Dec. 4, 2008

(54) Synthetic Aperture focusing techniques

(76) Inventors: Robert L. Morrison, JR., Watertown, MA (US); Minh N. Do, Champaign, IL (US); David C. Munson, JR., Dexter, MI (US)

Correspondence Address: KRIEG DEVAULT LLP, ONE INDIANA SQUARE, SUITE 2800, INDIANAPOLIS, IN, 46204-2079, US

(21) Appl. No.: 12/080,927

(22) Filed: Apr. 7, 2008

Related U.S. Application Data
(60) Provisional application No. 60/922,106, filed on Apr. 6, 2007.

(51) Int. Cl. G01S 13/90

(52) U.S. Cl. 342/25 F

(57) ABSTRACT

The present application describes an apparatus that includes a radar antenna device to acquire synthetic aperture radar data, radar receiver and transmitter equipment coupled to the radar antenna device, and a synthetic aperture radar processing device in communication with the radar receiver and transmitter equipment. This processing device includes a processor structured to process the synthetic aperture radar data, which is representative of a defocused image. The processor is further structured to define an image processing constraint corresponding to an image region expected to have a low radar return and generate one or more output signals as a function of the image processing constraint and the data. The one or more output signals are representative of a more focused form of the defocused image.

### CROSS-REFERENCE TO RELATED APPLICATIONS

The present application claims the benefit of U.S. Provisional Patent Application No. 60/922,106, filed Apr. 6, 2007, which is hereby incorporated by reference herein.

### FEDERALLY SPONSORED RESEARCH OR DEVELOPMENT

The present invention was made with Government assistance under National Science Foundation (NSF) Grant Contract Number CCR 0430877. The Government has certain rights in this invention.

### BACKGROUND

The present invention relates to processing techniques, and more particularly, but not exclusively, relates to focusing synthetic aperture radar.

Environmental monitoring, earth-resource mapping, and military systems are applications that frequently benefit from broad-area imaging at high resolutions. Sometimes such imagery is desired even when there is inclement weather or during night as well as day. Synthetic Aperture Radar (SAR) provides such a capability. SAR systems take advantage of the long-range propagation characteristics of radar signals and the complex information processing capability of modern digital electronics to provide high resolution imagery. SAR frequently complements photographic and other imaging approaches because time-of-day and atmospheric condition constraints are relatively minimal, and further because of the unique signature provided by some targets of interest to radar frequencies.

SAR technology has provided terrain structural information to geologists for mineral exploration, oil spill boundaries on water to environmentalists, sea state and ice hazard maps to navigators, and reconnaissance and targeting information to military operations. There are many other applications or potential applications. Some of these, particularly civilian, have not yet been adequately explored because lower cost electronics are just beginning to make SAR technology economical for smaller scale uses.

Unfortunately, standard SAR systems are susceptible to phase errors that can adversely impact a resulting image. In synthetic aperture radar imaging, demodulation timing errors at the radar receiver due to signal delays resulting from inaccurate range measurements or signal propagation effects sometime produce unknown phase errors in the imaging data. As a consequence of these errors, the resulting synthetic aperture radar images can be improperly focused. To address such shortcomings, autofocusing schemes have arisen that rely on a particular image model such as Phase Gradient Autofocus (PGA) approaches and/or optimization based on one or more particular image metrics, such as entropy, powers of image intensity, or knowledge of point scatterers to name a few. Unfortunately, the restoration tends to be inaccurate when the underlying scene is poorly described by the assumed image model. Also, implementation of these schemes often involves iterative calculations that tend to significantly consume processing resources. Thus, there is a need for further contributions in this area of technology.

### SUMMARY

One embodiment of the present invention includes a unique processing technique. Other embodiments include unique apparatus, devices, systems, and methods for focusing synthetic aperture radar. Further embodiments, forms, objects, features, advantages, aspects, and benefits of the present application shall become apparent from the detailed description and figures included herewith.

### BRIEF DESCRIPTION OF THE DRAWING

FIG. 1 is a diagrammatic view of a synthetic aperture radar processing system.

FIG. 2 is a flowchart of a procedure for MultiChannel Autofocusing (MCA) that can be implemented with the system of FIG. 1.

FIG. 3 is a diagrammatic view of a multichannel model of defocusing.

FIG. 4 is a spatial representation of an image with low-return rows.

FIG. 5 is a graphic representation of an antenna pattern superimposed on a scene reflectivity function for a single range coordinate.

FIGS. 6-9 depict an actual digital 2335 by 2027 pixel SAR image; where: FIG. 6 depicts the perfectly-focused image, FIG. 7 depicts a simulated sinc-squared antenna footprint to apply to each column image, FIG. 8 depicts the defocused image produced by applying a white phase error function, and FIG. 9 depicts the restored image (SNRₒᵤₜ=10.52 dB).

FIGS. 10-14 relate to experiments evaluating the robustness of MCA restoration as a function of the attenuation in the low-return region: FIG. 10 graphically depicts a window function applied to each column of the SAR image, where the gain at the edges of the window (corresponding to the low-return region) is varied with each experiment (a gain of 0.1 is shown); FIG. 11 is graphic plot of the quality metric SNRₒᵤₜ for the MCA restoration (measured with respect to the perfectly-focused image) versus the window gain in the low-return region; FIG. 12 is a simulated perfectly-focused 309 by 226 pixel image, where the window in FIG. 10 has been applied; FIG. 13 depicts a defocused image produced by applying a white phase error function; and FIG. 14 depicts the image restored per procedure 120 (SNRₒᵤₜ=9.583 dB).

FIGS. 15-20 are directed to comparison of the MCA process of procedure 120 to other autofocus approaches: FIG. 15 depicts a simulated 341 by 341 pixel perfectly-focused image, where the window function in FIG. 11 has been applied; FIG. 16 depicts a noisy defocused image produced by applying a quadratic phase error, where the input SNR is 40 dB (measured in the range-compressed domain); FIG. 17 depicts an image restored per MCA procedure 120 (SNRₒᵤₜ=25.25 dB); FIG. 18 depicts a standard PGA restoration (SNRₒᵤₜ=9.64 dB); FIG. 19 depicts a standard entropy-based restoration (SNRₒᵤₜ=3.60 dB); and FIG. 20 depict a restoration using a standard intensity-squared sharpness metric (SNRₒᵤₜ=3.41 dB).

FIG. 21 depict plots of the restoration quality metric SNRₒᵤₜ versus the input SNR for MCA restoration of the present application, PGA, entropy-minimization autofocus, and intensity-squared minimization autofocus.

FIGS. 22-25 relate to an experiment using entropy optimization as a regularization procedure to improve the MCA restoration when the input SNR is low, where the optimization is performed over a space of 15 basis functions determined by the smallest singular values of a matrix for MCA. FIG. 22 depicts a perfectly-focused image where a sinc-squared window is applied. FIG. 23 depicts a noisy defocused image with range compressed domain SNR of 19 dB produced using a quadratic phase error. FIG. 24 depicts an MCA restored image. FIG. 25 depicts regularized MCA restoration using the entropy metric.

### DETAILED DESCRIPTION OF REPRESENTATIVE EMBODIMENTS

While the present invention can take many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications of the described embodiments, and any further applications of the principles of the invention as described herein are contemplated as would normally occur to one skilled in the art to which the invention relates.

One embodiment of the present invention is directed to a technique of synthetic aperture radar (SAR) autofocus that is non-iterative. In this embodiment the multichannel redundancy of the defocusing operation has been utilized to create a linear subspace, where the unknown perfectly-focused image resides, expressed in terms of a known basis formed from the given defocused image. A unique solution for the perfectly-focused image is determined directly through a linear algebraic formulation by invoking an additional image support condition. This approach has been found to be computationally efficient and robust, and generally does not require prior assumptions about the SAR scene like those used in existing methods. As an optional feature of this embodiment, the vector-space formulation of the data facilitates incorporation of sharpness metric optimization within the image restoration framework as a regularization term.

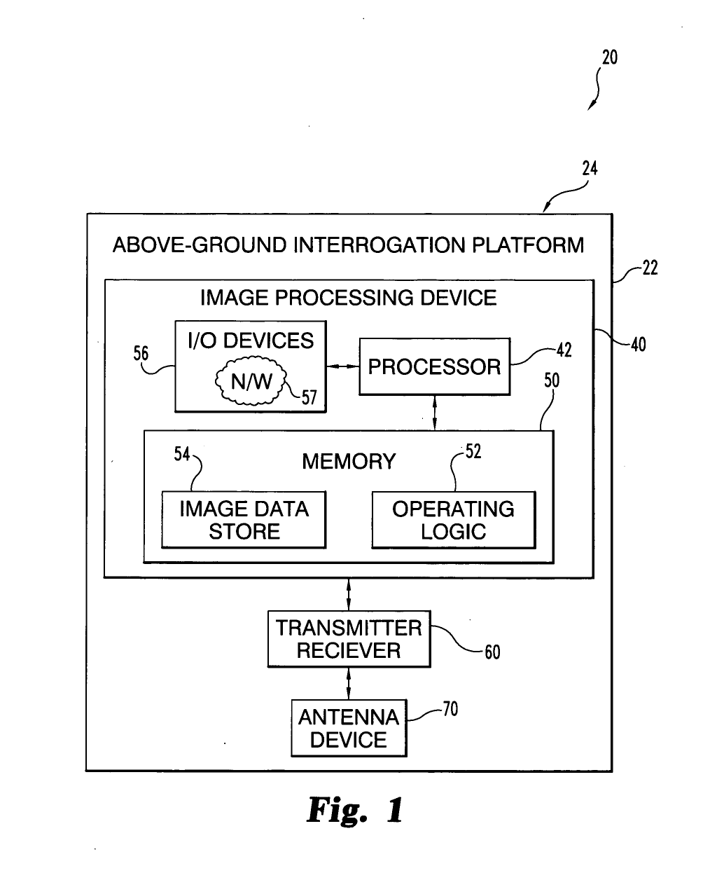

FIG. 1 depicts system 20 of another embodiment of the present invention. System 20 is directed to Synthetic Aperture Radar (SAR) interrogation and/or processing. System 20 includes an above-ground platform 22 in the form of aircraft 24. Alternatively, a satellite or other extra-terrestrial vehicle could be used, to name just a couple of alternatives. System 20 includes image processing device 40. Processing device 40 includes processor 42 operatively coupled to memory 50. Memory 50 includes storage of operating logic 52 for processor 42 in the form of executable instructions and image data store 54.

Image processing device 40 communicates with radar transmitter/receiver equipment 60. Equipment 60 is operatively coupled to radar antenna device 70. Equipment 60 and antenna device 70 operate to selectively provide electromagnetic energy in the radar range under control of processing device 40. The transmitter and receiver of equipment 60 may be separate units or at least partially combined. For terrain interrogation, typically SAR systems include at least a single radar antenna attached to the side of aircraft 24. During flight, a single pulse from the antenna tends to be rather broad (several degrees), and often illuminates the terrain from directly beneath aircraft 24 out to the horizon. However, if the terrain is approximately flat, the time at which the radar echoes return facilitates the determination of different distances from the aircraft flight track. While distinguishing points along the track of aircraft 24 can be difficult with a small antenna, if the amplitude and phase of the signal returning from a given portion of the terrain are recorded, and a series of pulses is emitted as aircraft 24 travels, then the results from these pulses can be combined. In effect, this series of observations can be combined just as if they had all been made simultaneously from a very large “virtual” antenna—resulting in a synthetic aperture much larger than the length of the antenna (and typically much larger than the platform 22).

Device 40 can be comprised of one or more components of any type suitable to process the signals received from equipment 60 and provide desired output signals. Such components may include digital circuitry, analog circuitry, or a combination of both. As illustrated, processor 42 is of a programmable type with operating logic 52 provided in the form of executable program instructions stored in memory 50. Alternatively or additionally, processor 42 and/or operating logic 52 are at least partially defined by hardwired logic or other hardware. Device 44 can further include multiple processors, Arithmetic-Logic Units (ALUs), Central Processing Units (CPUs), or the like. For forms of device 40 with multiple processing units, distributed, pipelined, and/or parallel processing can be utilized as appropriate. Device 40 includes signal conditioners, signal format converters (such as analog-to-digital and digital-to-analog converters), limiters, clamps, filters, power supplies, power converters, communication interfaces, operator interfaces, computer networking and the like as needed to perform various operations described herein. Device 40 may be dedicated to performance of just the operations described herein or may be utilized in one or more additional applications. Moreover, device 40 may be completely carried with platform 22 and/or at least a portion of device 40 may be remote from platform 22 at a ground station or the like, with pertinent data being downloaded or otherwise communicated to the remote station as desired.

Memory 50 can be of a solid-state variety, electromagnetic variety, optical variety, or a combination of these forms. Furthermore, memory 50 can be volatile, nonvolatile, or a mixture of these types. Some or all of memory 50 can be of a portable type, such as a disk, tape, memory stick, cartridge, or the like. Memory 50 can be at least partially integrated with processor 42 and/or may be in the form of one or more components or units.

Device 40 includes input/output (I/O) devices 56, such as one or more input devices like a keyboard, mouse or other pointing device, a voice recognition input subsystem, one or more output devices like an operator display that can be of a Cathode Ray Tube (CRT) type, Liquid Crystal Display (LCD) type, plasma type, Organic Light Emitting Diode (OLED) type, a printer, or the like. Other I/O devices 56 can be included such as loudspeakers, electronic wired or wireless communication subsystems, and the like. In FIG. 1, one further I/O arrangement of device 40 can include an interface with computer network (N/W) 57 via a communication channel or otherwise. Communications over such a network can be used to disseminate processed data results, to receive programming/operating logic updates, and/or to provide remote access as desired. In one nonlimiting implementation, information is communicated via N/W 57 while platform 22 is stationary on the ground using wireless and/or cable-based communication links.

Processing device 40 is structured to combine the series of observations provided by the SAR pulses and returns via equipment 60 and antenna device 70. SAR data is typically organized in terms of range (cross-track) and azimuth (along track); where the “track” is the direction of travel of platform 22, and can be retained in data store 54 of memory 50. This data is typically converted from the time domain to the frequency domain via Fourier transformation or another technique. The phase data of the frequency domain form of the data may be discarded in some of the more basic implementations, using only the magnitude data for image generation. The basic operation of a synthetic aperture radar system can be enhanced in various ways to collect more information. Most of these methods use the same basic principle of combining many pulses to form a synthetic aperture, but they may involve additional antennas and/or additional processing. Nonlimiting examples of these enhancements include polarimetry that exploits the polarization of interrogating radar signals and/or target materials, interferometry that can be used to improve resolution and/or provide additional mapping information, ultra-wideband techniques that can be used to enhance interrogation penetration, Doppler beam sharpening to improve resolution, and pulse compression techniques.

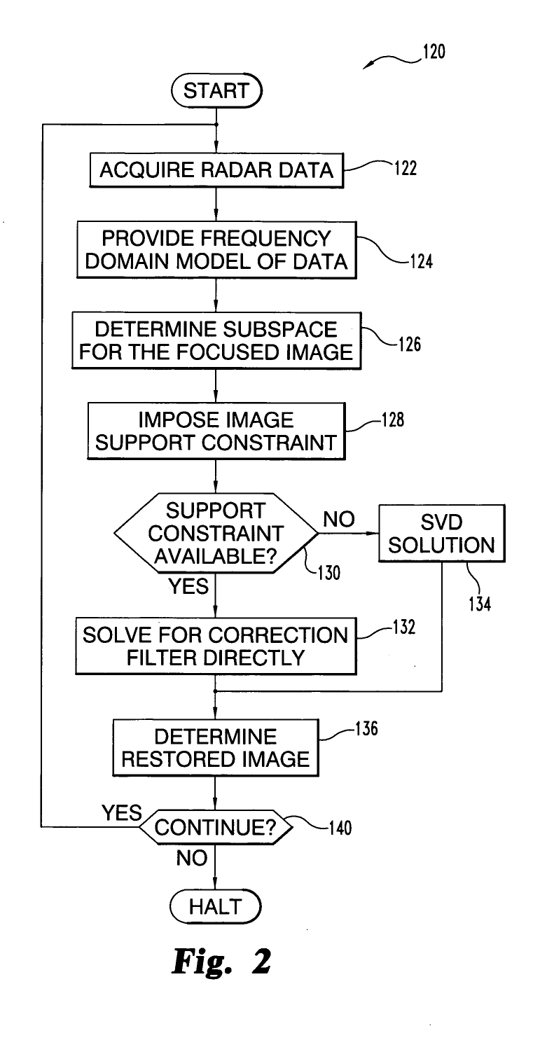

FIG. 2 represents SAR processing procedure 120 in flowchart form. Procedure 120 can be implemented with system 20 of FIG. 1 in accordance with operating logic 52 as executed by processor 42 of device 40. Procedure 120 begins with operation 122 in which synthetic aperture radar imaging data is gathered with the above-ground platform 22. In operation 124, this data is converted as necessary and stored in data store 54 of memory 50 in a frequency domain form, such as that provided by Fourier transformation. Synthetic aperture radar imaging systems are often subject to demodulation timing errors at the radar receiver that result from unknown delays in the received signals. Such delays can be due to uncertainties in the radar platform position, or due to signal propagation through a medium with spatially-varying propagation velocity. The effect of the demodulation timing errors is to cause the Fourier transform of the image data to be corrupted with multiplicative phase errors that lead to a defocused image.

It should be appreciated that the phase error of the SAR data can be modeled as varying only along one dimension in the Fourier domain. The following mathematical model relates the phase-corrupted Fourier imaging data \tilde{G} to the ideal data G through the one-dimensional phase error function φₑ as in expression (1) that follows:

\tilde{G}[k,n]=G[k,n]e^{jφ}^{ₑ}^{[k]} (1)

where: the row index k=0, 1, . . . , M−1 corresponds to the cross-range frequency index and the column index n=0, 1, . . . , N−1 corresponds to the range (spatial-domain) coordinate. The SAR image \tilde{g} is formed by applying an inverse one-dimensional (1-D) Fourier Transformation, such as a Digital Fourier Transform (DFT), to each column of \tilde{G}: \tilde{g}[m, n]=DFTₖ⁻¹{\tilde{G}[k, n]}. Because the phase error φₑ can be represented as a 1-D function of the index k, defocusing of each column of \tilde{g} can be modeled by applying the same blurring kernel, b[m] (where: b[m]=DFTₖ⁻¹{e^{jφ}^{ₑ}^{[k]}}, the defocused image, \tilde{g}, can be determined in accordance with expression (2) as follows:

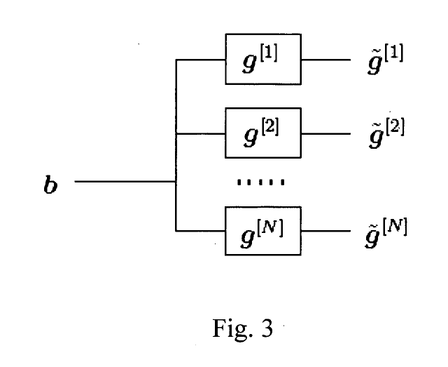

\tilde{g}[m,n]=g[m,n] [symbol] _{M}b[m], (2)

where: [symbol] M denotes an M-point circular convolution, and g is the perfectly-focused image. FIG. 3 diagrammatically illustrates the multichannel nature of defocusing; where: b is the blurring kernel, {g^{[n]}} represent the ideal, perfectly-focused image columns, and {\tilde{g}^{[n]}} are the defocused columns. FIG. 3 presents this analogy: the columns g^{[n]} of the perfectly-focused image g can be viewed as a bank of parallel filters that are excited by a common input signal, which is the blurring kernel b.

Procedure 120 continues with operation 126 in which a subspace is determined that includes the ideal, focused image. For this determination, let the column vector b∈C^{M} be composed of the values of b[m], m=0, 1, . . . , M−1 representative of the blurring kernel, and let column n of g[m, n], representing a particular range coordinate of a SAR image, be denoted by the vector g^{[n]}∈C^{M}. Let the vec{g}∈C^{MN} be composed of the concatenated columns g^{[n]}, n=0, 1, . . . , N−1, and the notation {A}_{Ω} refer to the matrix formed from a subset of the rows of A; where Ω is a set of row indices. Further, C{b}∈C^{MM} refers to a circulant matrix formed with the vector b as defined by the following expression (3):

$$C \{ b \} = [ \begin{matrix}b [ 0 ] & b [ M - 1 ] & … & b [ 1 ] \\ b [ 1 ] & b [ 0 ] & … & b [ 2 ] \\ ⋮ & ⋮ & ⋱ & ⋮ \\ b [ M - 1 ] & b [ M - 2 ] & ⋯ & b [ 0 ]\end{matrix} ] . \qquad ( 3 )$$

Given this notation, it should be appreciated that SAR autofocus aims to restore a perfectly-focused image g given the defocused image \tilde{g} and any assumptions about the characteristics of the underlying scene. Using expressions (1) and (2), the defocusing relationship in the spatial-domain can be represented by expression (4) as follows:

$$\tilde{g} = {\underbrace{{F}^{H} D ( {e}^{j {φ}_{e}} ) F}}_{C \{ b \}} g \qquad ( 4 )$$

where: F∈C^{M×M} is the 1-D DFT unitary matrix with entries

$${F}_{k , m} = \frac{1}{\sqrt{M}} {e}^{- j 2 π k m / M} ,$$

F^{H} is the Hermitian of F and represents the inverse DFT, D{e^{jφ}^{ₑ}^{[k]}}∈C^{M×M} is a diagonal matrix with the entries e^{jφ}^{ₑ}^{[k]} on the diagonal, and C{b}∈C^{M×M} is a circulant matrix formed with the blurring kernel b, such that b[m]=DFTₖ⁻¹{e^{jφ}^{ₑ}^{[k]}}. Accordingly, the defocusing effect can be described as the multiplication of the focused image by a circulant matrix with eigenvalues equal to the unknown phase errors. The resulting solution space is the set of all images formed from \tilde{g} with different φ as set forth in expression (5) as follows:

$$\hat{g} ( φ ) = \underbrace{( {F}^{H} D ( {e}^{- jφ} ) F )}_{C \{ {f}_{A} \}} \tilde{g} \qquad ( 5 )$$

where: f_{A} is an all-pass correction filter, noting that ĝ(φₑ)=g. Theoretically, the estimated phase error, \hat{φ}, can be applied directly to the corrupt imaging data \tilde{G} to restore the focused image according to expression (6) that follows:

ĝ[m,n]=DFTₖ⁻¹{\tilde{G}[k,n]e^{-j\hat{φ}[k]}}. (6)

However, to solve for the desired image in this manner typically leads to iterative schemes that evaluate some measure of quality in the spatial domain and then perturb the estimate of the phase error function in a manner that increases the image focus. In at least some applications, a more direct, non-iterative approach is desired in which a focusing operator f is directly determined to restore the image. From this focusing operator, it is generally straightforward to obtain \hat{φ}=φₑ.

In one such approach, a linear subspace characterization of the focused image g is used, which allows the focusing operator to be computed using a linear algebraic formulation. This subspace is spanned by a basis constructed from the given defocused image \tilde{g}. To determine such a subspace, the relationship set forth in expression (5) is generalized to include all correction filters f∈C^{M×M}—not just the subset of all-pass correction filters f_{A}. As a result, for a given defocused image \tilde{g}, an M-dimensional subspace is obtained that includes the focused image g, as provided in expression (7) that follows:

ĝ(f)=C{f}\tilde{g}, (7)

where: ĝ(f) denotes the restoration formed by applying the focus operator f. This subspace characterization explicitly captures the multichannel condition of SAR autofocus based on the model that each column of the image is defocused by the same blurring kernel. To produce a basis expansion for the subspace in terms of \tilde{g}, the standard basis {eₖ}ₖ₌₀^{M-1} for C^{M} is selected, i.e., eₖ[m]=1 if m=k and 0 otherwise, and express the correction filter as provided in expression (8a) that follows:

$$f = {\sum }_{k = 0}^{M - 1} {f}_{k} {e}_{k} . \qquad ( 8 a )$$

By generalizing to all f∈C^{M}, a linear framework arises that may not result from initial application of the all-pass condition. Using the linearity property of circular convolution, expression (8b) results:

$$C \{ f \} = {\sum }_{k = 0}^{M - 1} {f}_{k} C \{ {e}_{k} \} . \qquad ( 8 b )$$

From this relationship, any image ĝ in the subspace can be expressed in terms of a basis expansion as set forth in expression (9) as follows:

$$\hat{g} ( f ) = {\sum }_{k = 0}^{M - 1} {f}_{k} {ϕ}^{[ k ]} ( \tilde{g} ) , \qquad ( 9 )$$

where expression (10) defines:

φ^{[k]}(\tilde{g})=C{eₖ}\tilde{g} (10)

Because \tilde{g} is given, the basis functions of expression (10) are known for the M-dimensional subspace containing the unknown focused image g. In matrix form, expression (9) can be written as expression (11):

vec{\hat{g}(f)}=Φ(\tilde{g})f (11)

where expression (12) defines:

$$Φ ( \tilde{g} ) {=}^{def} [ vec \{ {ϕ}^{[ 0 ]} ( \tilde{g} ) \} , vec \{ {ϕ}^{[ 1 ]} ( \tilde{g} ) \} , … , vec \{ {ϕ}^{[ M - 1 ]} ( \tilde{g} ) \} ] \qquad ( 12 )$$

and is designated the basis matrix. The unknown perfectly-focused image is represented in terms of the basis expansion in expression (9) as follows in expression (13):

vec{g}=Φ(\tilde{g})f*, (13)

where: f* is the true correction filter satisfying ĝ(f*)=g. For expression (13), the matrix Φ(\tilde{g}) is known, but g and f* are unknown.

From the subspace definition determined in operation 126, procedure 120 continues with operation 128 in which an image support constraint is imposed. By imposing an image support constraint on the focused image g, the linear system in expression (13) can be constrained sufficiently to solve for the unknown correction filter f*. This constraint assumes that g is approximately zero-valued over a particular set of low-return pixels, as represented by expression (14):

$$g [ m , n ] = \{ \begin{matrix}ξ [ m , n ] & for m , n ∈ Ω \\ {g}^{′} [ m , n ] & for m , n ∉ Ω ,\end{matrix} \qquad ( 14 )$$

where: ξ[m, n] are low-return pixels (such that |ξ[m, n]|≈0) and g′[m, n] are unknown nonzero pixels. Letting Q̅ be the set of nonzero pixels (i.e., the complement of Ω), these pixels correspond to a region of support (ROS) for the image of interest. In practice, the desired image support condition can be achieved by exploiting the spatially-limited illumination of the antenna beam, or by using prior knowledge of low return regions in the SAR image.

From operation 128, conditional 130 is reached which tests the constraint to determine if an acceptable support constraint is available. If the test of conditional 130 is true (yes), then procedure 120 proceeds to operation 132. With a zero or near nonzero image support constraint, operation 132 provides as direct solution. Applying the spatially-limited constraint of expression (14) to the multichannel framework of expression (13), expression (15) results as follows:

$$[ \begin{matrix}ξ \\ vec \{ {g}^{′} \}\end{matrix} ] = [ \begin{matrix}\{ Φ ( \tilde{g} ) \} Ω \\ \{ Φ ( \tilde{g} ) \} \overline{Ω}\end{matrix} ] {f}^{*} \qquad ( 15 )$$

where ξ={vec{g}} is a vector of the low-return constraints, {Φ(\tilde{g})}_{Ω} are the rows of Φ(\tilde{g}) that correspond to the low-return constraints, and {Φ(\tilde{g})} _{Ω̅} are the rows of Φ(\tilde{g}) that correspond to the unknown pixel values of g within the ROS. Given that ξ has dimension M−1 or greater (i.e., there are at least M−1 zero constraints), when ξ=0 the correction filter f* can be uniquely determined up to a scaling constant by solving for f from expression (16):

{Φ(\tilde{g})}_{Ω}f=0. (16)

For this MultiChannel Autofocus (MCA) approach of determining the correction filter, define

$${Φ}_{Ω} ( \tilde{g} ) {=}^{def} \{ Φ ( \tilde{g} ) \} Ω .$$

to be the MCA matrix formed using the constraint set with rank M−1 matrix. The solution \hat{f} for expression (16) can be obtained by determining the unique vector spanning the nullspace of Φ_{Ω}(\tilde{g}) as set forth in expression (17):

\hat{f}=Null(Φ_{Ω}(\tilde{g}))=αf*, (17)

where α is an arbitrary complex constant. To eliminate magnitude scaling α, the Fourier phase of \hat{f} corrects the defocused image according to expression (6) as set forth in expression (18):

\hat{φ}[k]=−∠(DFTₘ{\hat{f}[m]}). (18)

Accordingly, the all-pass condition of \hat{f} is enforced to determine a unique solution from expression (17).

When the test of conditional 130 is false (no), procedure 120 branches to operation 134. This negative outcome may result, for example, when |ξ[m, n]|≠0 as set forth in expression (14) or the defocused image is contaminated by additive noise, for example, such that the MCA matrix has full column rank. In this case, \hat{f} cannot be obtained as the null vector of Φ_{Ω}(\tilde{g}). Accordingly, operation 134 applies a Singular Value Decomposition (SVD) process to Φ_{Ω}(\tilde{g}), determining a unique vector that produces the minimum gain solution (in the l2-sense). SVD is represented by expression (19) as follows:

Φ_{Ω}(\tilde{g})=Ũ\tilde{Σ}\tilde{V}^{H}, (19)

where: \tilde{Σ}=diag(σ1, σ2, . . . , σ_{M}) is a diagonal matrix of the singular values satisfying σ1≧σ2≧ . . . ≧σM≧0. Because f is an all-pass filter, ∥f∥₂=1 results. Although it cannot be assumed that the pixels in the low-return region are exactly zero, it is reasonable to require the low-return region to have minimum energy subject to |f|₂=1. A solution \hat{f} satisfying expression (20):

$$\hat{f} = arg {min}_{{‖ f ‖}_{2} = 1} {‖ {Φ}_{Ω} ( \tilde{g} ) f ‖}_{2} \qquad ( 20 )$$

is given by \hat{f}=\tilde{V}^{M}, which is the right singular vector corresponding to the smallest singular value of Φ_{Ω}(\tilde{g}) as set forth in G. H. Golub and C. F. Van Loan, Matrix Computations, Johns Hopkins University Press, Baltimore, 1996, which is hereby incorporated by reference.

From operations 132 and 134, procedure 120 continues with operation 136. In operation 136, the restored SAR image is determined for further use or processing as desired. From operation 136, conditional 140 is reached. Conditional 140 tests whether to continue execution of procedure 120 by acquiring and processing another image. If the test of conditional 140 is true (yes), then procedure returns to operation 122 to repeat various operations and conditionals as appropriate. If the test of conditional 140 is false (no), then procedure 120 halts.

With respect to procedure 120, it should be appreciated that while both the channel responses (i.e., focused image columns) and input (i.e., blurring kernel) are unknown, it is desired to reconstruct the channel responses from available output signals (i.e., defocused image columns) analogous to a Blind Multichannel Deconvolution (BMD) approach. In contrast, it should be appreciated that the filter operator of procedure 120 is described by circular convolution, as opposed to standard discrete-time convolution, and the channel responses g[n], n=0, 1, . . . , N−1, of procedure 120 are not short-support FIR filters—instead having support over the entire signal length. It should be observed that procedure 120 directly solves for a common focusing operator f (i.e., the inverse of the blurring kernel b) through explicit characterization of the multichannel condition of the SAR autofocus problem by constructing a low-dimensional subspace where the focused image resides. This subspace characterization provides a linear framework through which the focusing operator can be directly determined by constraining a small portion of the focused image to be zero-valued or correspond to a region of low return. This constraint facilitates solving for the focusing operator from a linear system of equations in a noniterative fashion. Frequently in certain implementations, the constraint on the underlying image may be enforced approximately by acquiring Fourier domain data that are sufficiently oversampled in the cross-range dimension so that the coverage of the image extends beyond the brightly illuminated portion of the scene determined by the antenna pattern, which is further described in C. V. Jakowatz, Jr., D. E. Wahl, P. H. Eichel, D. C. Ghiglia, and P. A. Thompson, Spotlight-Mode Synthetic Aperture Radar: A Signal Processing Approach, Kluwer Academic Publishers, Boston, 1996.

The MCA approach is typically found to be computationally efficient, and robust in the presence of noise and deviations from the image support assumption. In addition, performance of procedure 120 does not generally depend on the nature of the phase error. It should also be appreciated that general properties of Φ_{Ω}(\tilde{g}) resulting in the solution of procedure 120 follow from the observation that the circulant blurring matrix C{b} is unitary. This result is arrived at using expression (4), where all the eigenvalues of C{b} are observed to have unit magnitude, and the fact that the DFT matrix, F, is unitary, as follows in expression (21):

C{b}C^{H}{b}=F^{H}D(e^{jφ}^{ₑ})FF^{H}D(e^{-jφ}^{ₑ})F=I. (21)

The basis matrix Φ(\tilde{g}) has an alternative structure by rewriting expression (7) for a single column as set forth in expression (22):

ĝ^{[n]}(f)=f [symbol] _{M}\tilde{g}^{[n]}=C{\tilde{g}^{[n]}}f. (22)

Comparing with expression (11), where the left side of the equation is formed by stacking the column vectors ĝ^{[n]}(f), and using expression (22), expression (23) results:

$$Φ ( \tilde{g} ) = [ \begin{matrix}C \{ {\tilde{g}}^{[ 0 ]} \} \\ C \{ {\tilde{g}}^{[ 1 ]} \} \\ ⋮ \\ C \{ {\tilde{g}}^{[ M - 1 ]} \}\end{matrix} ] . \qquad ( 23 )$$

Analogous to expression (12), let Φ(g) be the basis matrix formed by the perfectly-focused image g, i.e., Φ(g) is formed by using g instead of \tilde{g} in expression (12). Likewise, Φ_{Ω}(g)={Φ(g)}_{Ω} is the MCA matrix formed from the perfectly-focused image. From the unitary property of C{b}, the following proposition results (equivalence of singular values): suppose that \tilde{g}=C{b}g, then Φ_{Ω}(\tilde{g})=Φ_{Ω}(g)C{b} and the singular values of Φ_{Ω}(g) and Φ_{Ω}(\tilde{g}) are identical. Proof for this proposition follow from the assumption:

\tilde{g}^{[n]}=b [symbol] _{M}g^{[n]}.

Therefore, C{\tilde{g}^{[n]}}=C{g^{[n]}}C{b}, and from expression (23), expression (24) results:

$$Φ ( \tilde{g} ) = [ \begin{matrix}C \{ {g}^{[ 0 ]} \} C \{ b \} \\ C \{ {g}^{[ 1 ]} \} C \{ b \} \\ ⋮ \\ C \{ {g}^{[ M - 1 ]} \} C \{ b \}\end{matrix} ] = Φ ( g ) C \{ b \} . \qquad ( 24 )$$

which implies:

{Φ(\tilde{g})}_{Ω}={Φ(g)}_{Ω}C{b}.

As a result, it follows that:

Φ_{Ω}(\tilde{g})Φ_{Ω}^{H}(\tilde{g})=Φ_{Ω}(g)C{b}C^{H}{b}Φ_{Ω}^{H}(g)=Φ_{Ω}(g)Φ_{Ω}^{H}(g),

thus Φ_{Ω}(g) and Φ_{Ω}(\tilde{g}) have the same singular values. From this proposition, the SVD of the MCA matrices for g and \tilde{g} can be written as:

Φ_{Ω}(g)=UΣV^{H} and Φ_{Ω}(\tilde{g})=ŨΣ\tilde{V}^{H}, respectively.

The following result demonstrates that the MCA restoration obtained through Φ_{Ω}(\tilde{g}) and \tilde{g} is the same as the restoration obtained using Φ_{Ω}(g) and g.

Another proposition is directed to equivalence of restorations: suppose that Φ_{Ω}(g) (or equivalently Φ_{Ω}(\tilde{g}) has a distinct smallest singular value, then applying the MCA correction filters V^{[M]} and \tilde{V}^{M} to g and \tilde{g}, respectively, produce the same restoration in absolute values; i.e., expression (25) results:

|C{\tilde{V}^{[M]}}\tilde{g}|=|C{V^{[M]}}g|. (25)

Proof for this proposition: expressing Φ_{Ω}(\tilde{g})=Φ_{Ω}(g)C{b} in terms of the SVD of Φ_{Ω}(g) and Φ_{Ω}(\tilde{g}), results in expression (26):

Φ_{Ω}(\tilde{g})=\tilde{g}Σ\tilde{g}^{H}=UΣV^{H}C{b}. (26)

Because of the assumption in the proposition, the right singular vector corresponding to the smallest singular value of Φ_{Ω}(\tilde{g}) is uniquely determined to within a constant scalar factor β of absolute value one as described in G. H. Golub and C. F. Van Loan, Matrix Computations, Johns Hopkins University Press, Baltimore, 1996. Expression (27) results:

\tilde{V}^{[M]H}=βV^{[M]H}C{b}, (27)

where |β|=1. Taking the transpose of both sides of expression (27) produces:

\tilde{V}^{[M]}=βC^{H}{b}V^{[M]}.

Using the unitary property of C{b}, expression (28) results:

V^{[M]}=β⁻¹C{b}\tilde{V}^{[M]}. (28)

It follows that:

$$\begin{matrix}C \{ {V}^{[ M ]} \} g = {β}^{- 1} C \{ b \} C \{ {\tilde{V}}^{[ M ]} \} g \\ = {β}^{- 1} C \{ {\tilde{V}}^{[ M ]} \} C \{ b \} g \\ = {β}^{- 1} C \{ {\tilde{V}}^{[ M ]} \} \tilde{g} ,\end{matrix}$$

and thus C[V^{[m]}}g and C[\tilde{V}^{[m]}}\tilde{g} have the same absolute value because |β−1|=1. This proposition demonstrates that applying MCA to the perfectly focused image or any defocused image described by expression (4) produces the same restored image (with respect to display of image magnitude) such that the restoration formed using the MCA approach does not depend on the phase error function. Instead, the MCA restoration depends on g and the selection of low-return constraints (i.e., the pixels in g designated to be low-return). It also results from this proposition that it is sufficient to examine the perfectly-focused image to determine the conditions under which unique restorations are possible using MCA.

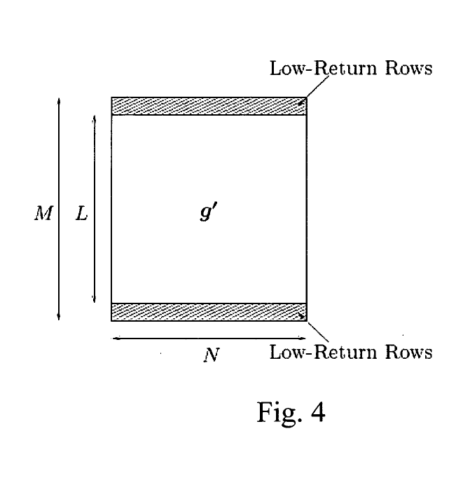

In one case of interest, Ω corresponds to a set of low-return rows. The consideration of row constraints matches a practical case of interest where the attenuation due to the antenna pattern is used to satisfy the low-return pixel assumption. In this case, Φ_{Ω}(g) has a structure that can be exploited for efficient computation in the typical case. This form also allows the necessary conditions for a unique correction filter to be precisely determined. FIG. 4 illustrates the spatially-limited image support assumption in the case where there are low-return rows in the focused image; where there are L rows within the ROS (Region Of Support), and the top and bottom rows are low-return. Let the set L={l₁, l₂, . . . , l_{R}} be the set of low-return row indices, where R=M−L is the number of low-return rows and 0≦lj≦M−1, such that expression (29) defines:

$$g [ m , n ] = \{ \begin{matrix}ξ [ m , n ] & for m ∈ ℒ \\ {g}^{′} [ m , n ] & for m ∉ ℒ .\end{matrix} \qquad ( 29 )$$

To explicitly construct the MCA matrix in this case, expression (7) results in expression (30) at follows:

g^{T}=\tilde{g}^{T}C^{T}{f*}, (30)

where T denotes a transpose operator. The transposed images represent the low-return rows in g as column vectors, which leads to a relationship in the form of expression (16) where Φ_{Ω}(\tilde{g}) is explicitly defined. Accordingly, expression (31) results:

C^{T}{f}=[f_{F},C{e₁}f_{F}, . . . , C{e_{M-1}}f_{F}], (31)

where C{e₁} is the l-component circulant shift matrix, and expression (32) defines:

f_{F}[m]=f[ [symbol] −m [symbol] _{M}], (32)

m=0, 1, . . . , M−1, is a flipped version of the true correction filter [symbol] n [symbol] _{M} denotes n modulo M). Using expressions (30) and (31), the l-th row of g is defined by expression (33) as:

(g^{T})^{[l]}=\tilde{g}^{T}C{eₗ}f*_{F}. (33)

Note that multiplication with the matrix C{el} in the expression above results in an l-component left circulant shift along each row of \tilde{g}^{T}. The relationship in expression (33) shows how the MCA matrix Φ_{Ω}(\tilde{g}) can be constructed given the image support constraint in expression (29). For the low-return rows satisfying (g^{T})^{[lj]}≈0, the relation of expression (34) is set forth as follows:

(g^{T})^{[l}^{ⱼ}^{]}=\tilde{g}^{T}C{elⱼ}f*_{F}≈0 (34)

for j=1, 2, . . . , R. Applying expression (34) for all of the low-return rows simultaneously results in expression (35):

$$0 \approx \underbrace{[ \begin{matrix}{\tilde{g}}^{T} C \{ {e}_{{l}_{1}} \} \\ {\tilde{g}}^{T} C \{ {e}_{{l}_{2}} \} \\ ⋮ \\ {\tilde{g}}^{T} C \{ {e}_{{l}_{R}} \}\end{matrix} ]}_{{Φ}_{ℒ} ( \tilde{g} )} {f}_{F}^{*} , \qquad ( 35 )$$

where (with abuse of notation) Φ_{L}(\tilde{g})∈C^{NR×M} is the MCA matrix for the row constraint set L. In this case, Φ_{L} plays the same role as Φ_{Ω} for the general case. Thus, the MCA matrix is formed by stacking shifted versions of the transposed defocused image, where the shifts correspond to the locations of the low-return rows in the perfectly-focused image. Determining the null vector (or minimum right singular vector) Φ_{L}(\tilde{g}) as defined in expression (35) produces a flipped version of the correction filter. The correction filter f can be obtained by appropriately shifting the elements of f_{F} according to expression (32). The reason for considering the flipped form in expression (35) is that it can provide a structure well-suited to efficiently compute f if desired.

To determine necessary conditions for a unique and correct solution of the MCA expression (16), there is a restriction of the model in expression (29) to low-return rows that are identically zero: ξ[m, n]=0. From the previous propositions, the conditions for a unique solution to expression (16) can be determined using Φ_{L}(g) in place of Φ_{L}(\tilde{g}). This approach in turn is equivalent to requiring Φ_{L}(g) to be a rank M−1 matrix.

As a further proposition, consider the image model g[m, n]=0 for m∈L and g[m, n]=g′[m, n] for m∉L, then a necessary condition for MCA to produce a unique and correct solution to the autofocus problem is set forth in expression (36):

$$rank ( {g}^{′} ) \geq \frac{M - 1}{R} . \qquad ( 36 )$$

As proof, note that:

$$\begin{matrix}rank ( {\tilde{g}}^{T} C \{ {e}_{{l}_{j}} \} ) = rank ( \tilde{g} ) \\ = rank ( C \{ b \} g ) \\ = rank ( g ) \\ = rank ( {g}^{′} ) ,\end{matrix}$$

because C{eₗ_{ⱼ}} and C{b} are unitary matrices, and the zero-row assumption of the image g; then from expression (35):

rank(Φ [symbol] (\tilde{g}))≦Rrank(g′).

Therefore, a necessary condition to be a rank (Φ_{L}(\tilde{g}))=M−1 is rank(g′)≧(M−1)/R. Furthermore, note that the filter f_{ld}=[1, 0, . . . , 0]T is always a solution to expression (16) for g as defined in the proposition statement: Φ_{L}(g)f_{ld}=0 because applying f_{ld} to g returns the same image g, where all the pixels in the low-return region are zero by assumption. Thus, the unique solution for expression (16) is also the correct solution to the autofocus problem. Noting that M=R+L, and using the condition of expression (36), the minimum number of zero-return rows R required to achieve a unique solution as a function of the rank of g′ is set forth by expression (37):

$$R \geq \frac{L - 1}{rank ( {g}^{′} ) - 1} . \qquad ( 37 )$$

The condition rank(g)=min(L,N) usually holds, with the exception of degenerate cases where the rows or columns of g′ are linearly dependent. Because rank(g′)≦min(L,N), expression (37) implies expression (38) as follows:

$$R \geq \frac{L - 1}{min ( L , N ) - 1} . \qquad ( 38 )$$

The condition in expression (38) provides a rule for determining the minimum R (the minimum number of low-return rows required) as a function of the dimensions of the ROS in the general case where ξ[n,m]≠0.

Due to the structure of Φ_{L}(\tilde{g}), it is possible to efficiently compute the minimum right singular vector solution in expression (20) even when the formation of the MCA matrix according to expression (35) results in many low-return rows that lead to dimensions of Φ_{L}(\tilde{g}) with NR rows by M columns. As an example, for a 1000 by 1000 pixel image with 100 low-return rows, Φ_{L}(\tilde{g}) is a 100000×1000 matrix. In such a case, it often not practical to construct and invert such a large matrix. However, the right singular vectors of Φ_{L}(\tilde{g}), can be determined by solving for the eigenvectors for the expression (39) that follows:

B [symbol] (\tilde{g})=Φ [symbol] ^{H}(\tilde{g})Φ [symbol] (\tilde{g}) (39)

Without exploiting the structure of the MCA matrix, forming B_{L}(\tilde{g})∈C^{M×M} and computing its eigenvectors requires O(NRM²) operations. Using expression (35), the matrix product of expression (39) can be set forth as in expression (40):

$${B}_{ℒ} ( \tilde{g} ) = {\sum }_{j = 1}^{R} {C}^{T} \{ {e}_{{l}_{j}} \} {\tilde{g}}^{*} {\tilde{g}}^{T} C \{ {e}_{{l}_{j}} \} , \qquad ( 40 )$$

where: \tilde{g}*=(\tilde{g}^{T})^{H} (i.e., all of the entries of \tilde{g} are conjugated). Let H(\tilde{g})=\tilde{g}*\tilde{g}^{T}. The effect of C^{T}{eₗ_{ⱼ}} in expression (40) is to circularly shift H(\tilde{g}) up by lj pixels along each column, while C{eₗ_{ⱼ}} circularly shifts H(\tilde{g}) to the left by lj pixels along each row. Thus, H(\tilde{g}) can be computed once initially, and then B_{L}(\tilde{g}) can be formed by adding shifted versions of H(\tilde{g}), which requires only O(NM²) operations. Thus, the computation has been reduced by a factor of R. In addition, the memory requirements have also been reduced by R times (assuming M≈N), because only H(\tilde{g})∈C^{M×M} needs to be stored, as opposed to Φ_{L}^{H}(\tilde{g})∈C^{NR×M}. As a result, the total cost of constructing B_{L}(\tilde{g}) and performing its Eigen decomposition is O(NM²) (when M≦N).

As an option, the vector space framework of the MCA approach allows sharpness metric optimization to be incorporated as a regularization procedure. The use of sharpness metrics can improve the solution when multiple singular values of Φ_{Ω}(\tilde{g}) are close to zero. Such a condition can occur if the focused SAR image is very sparse (effectively low rank). In addition, metric optimization can be beneficial in cases where the low-return assumption |ξ[m, n]|≈0 holds weakly, or where additive noise with large variance is present. In these nonideal scenarios, the MCA framework provides an approximate reduced-dimension solution subspace, where the optimization may be performed over a small set of parameters.

Suppose that instead of knowing that the image pixels in the low-return region are exactly zero, it is assumed that expression (41) applies:

∥{vec{g}}_{Ω}∥₂²≦c (41)

for some specific constant c. Then, the MCA condition can be represented by expression (42) as follows:

∥Φ_{Ω}(\tilde{g})f∥₂²≦c∥f∥₂². (42)

The true correction filter f* satisfies expression (42). The goal of using sharpness optimization is to determine the best f (in the sense of producing an image with maximum sharpness) that satisfies expression (42). To derive a reduced-dimension subspace for performing the optimization where expression (42) holds for all f in the subspace, first determine σ_{M-K+1}, which is defined as the largest singular value of Φ_{Ω}(\tilde{g}) satisfying σₖ²≦c. Then express f in terms of the basis formed from the right singular vectors of Φ_{Ω}(\tilde{g}) corresponding to the K smallest singular values, i.e., expression (43) applies:

$$f = {\sum }_{k = M - K + 1}^{M} {v}_{k} {\tilde{V}}^{[ k ]} , \qquad ( 43 )$$

where υₖ is a basis coefficient corresponding to the basis vector \tilde{V}^{[k]}. To demonstrate that every element of the K-dimensional subspace in expression (43) satisfies expression (42), define:

S_{K}*=span{\tilde{V}^{[M-K+1]}, \tilde{V}^{[M-K+2]}, . . . , \tilde{V}^{[M]}},

and note that expression (44) applies as follows:

$$\begin{matrix}{max}_{{{‖ f ‖}_{2} = 1}_{f ∈ {S}_{K}^{*}}} {‖ {Φ}_{Ω} ( \tilde{g} ) f ‖}_{2}^{2} = {max}_{{{‖ f ‖}_{2} = 1}_{f ∈ {S}_{K}^{*}}} {‖ \tilde{U} \sum {\tilde{V}}^{H} f ‖}_{2}^{2} \\ = {max}_{{{‖ v ‖}_{2} = 1}_{{v}_{1} = {v}_{2} = … = {v}_{M - K} = 0}} {‖ \sum v ‖}_{2}^{2} \\ = {max}_{{‖ v ‖}_{2} = 1} {\sum }_{k = M - K + 1}^{M} {σ}_{k}^{2} {\vert {v}_{k} \vert}^{2} = {σ}_{M - K + 1}^{2} \leq c ,\end{matrix} \qquad ( 44 )$$

where: υ=\tilde{V}^{H}f. In the second equality, the unitary property of \tilde{V} is used to obtain ∥f∥₂=∥υ∥₂, and also f=\tilde{V}υ, from which it is observed that:

f∈S_{K}* implies υ₁=υ₂= . . . =υ_{M-K}=0.

It should be appreciated that the indicated subspace does not contain all f satisfying expression (42); however, it provides an optimal K-dimensional subspace in the following sense: for any subspace S_{K} where dim(S_{K})=K, expression (45) applies as follows:

$${max}_{{{‖ f ‖}_{2} = 1}_{f ∈ {S}_{K}}} {‖ {Φ}_{Ω} ( \tilde{g} ) f ‖}_{2}^{2} \geq {max}_{{{‖ f ‖}_{2} = 1}_{f ∈ {S}_{K}^{*}}} {‖ {Φ}_{Ω} ( \tilde{g} ) f ‖}_{2}^{2} = {σ}_{M - K + 1}^{2} . \qquad ( 45 )$$

Accordingly, this subspace is a preferred K-dimensional subspace in that every element is feasible (i.e., satisfies expression (42)), and among all K-dimensional subspaces this subspace minimizes the maximum energy in the low-return region. Substituting the basis expansion expression (43) for f into expression (7) allows g to be expressed in terms of an approximate reduced-dimension basis as represented by expression (46):

$${g}_{d} = {\sum }_{k = 1}^{K} {d}_{k} {ψ}^{[ k ]} , \qquad ( 46 )$$

where expression (47) defines:

ψ^{[k]}=C{\tilde{V}^{[M-K+k]}}\tilde{g}, (47)

dₖ=υ_{M-K+k}, and g_{d} is the image parameterized by the basis coefficients d=[d₁, d₂, . . . , d_{K}]^{T}. To obtain the best ĝ that satisfies the data consistency condition, a particular sharpness metric is optimized over the coefficients d, where the number of coefficients K<<M.

To perform metric optimization, define the metric objective function C: C^{K}→R as the mapping from the basis coefficients d=[d₁, d₂, . . . , d_{K}]^{T} to a sharpness cost as set forth by expression (48):

$$C ( d ) = {\sum }_{m = 0}^{M - 1} {\sum }_{n = 0}^{N - 1} S ( {\overline{I}}_{d} [ m , n ] ) , \qquad ( 48 )$$

where I_{d}[m, n]=|g_{d}[m, n]|² is the intensity of each pixel, Ī_{d}[m, n]=I_{d}[m, n]/γ_{g}_{_{d}} is the normalized intensity with γ_{g}_{_{d}}=∥g_{d}∥₂², and S: [symbol] ⁺→ [symbol] is an image sharpness metric operating on the normalized intensity of each pixel. An example of a commonly used sharpness metric in SAR is the image entropy set forth as:

$${S}_{H} ( {\overline{I}}_{d} [ m , n ] ) {=}^{def} - {\overline{I}}_{d} [ m , n ] ln {\overline{I}}_{d} [ m , n ]$$

and further, a gradient-based search can be used to determine a local minimizer of C(d) as described in D. G. Luenberger, Linear and Nonlinear Programming, Kluwer Academic Publishers, Boston, 2003. The k-th element of the gradient ∇_{d}C(d) is determined using expression (49) as follows:

$$\frac{\partial C ( d )}{\partial {d}_{k}} = {\sum }_{m , n} \frac{\partial S ( {\overline{I}}_{d} [ m , n ] )}{\partial {\overline{I}}_{d} [ m , n ] )} ( \begin{matrix}\frac{2}{{γ}_{{g}_{d}}} {g}_{d} [ m , n ] {ψ}^{* [ k ]} [ m , n ] - \frac{2}{{γ}_{{g}_{d}}^{2}} \\ {I}_{d} [ m , n ] {\sum }_{{m}^{′} , {n}^{′}} {g}_{d} [ {m}^{′} , {n}^{′} ] {ψ}^{* [ k ]} [ {m}^{′} , {n}^{′} ]\end{matrix} ) , \qquad ( 49 )$$

where * denotes the complex conjugate. It should be appreciated that expression (49) can be applied to a variety of sharpness metrics. Considering the entropy example, the derivative of the sharpness metric is: ∂S_{H}(Ī_{d}[m,n])/∂Ī_{d}[m,n]=−(1+lnĪ_{d}[m,n]).

In applying procedure 120, one way to satisfy the image support assumption used in MCA is to exploit the SAR antenna pattern. In spotlight mode SAR, the area of terrain that can be imaged depends on the antenna footprint, i.e., the illuminated portion of the scene corresponding to the projection of the antenna main-beam onto the ground plane. There is low return from features outside of the antenna footprint. The fact the SAR image is essentially spatially-limited, due to the profile of the antenna beam pattern, suggests that the autofocus technique can be applied in spotlight-mode SAR imaging with a sufficiently high sampling rate.

The amount of area represented in a SAR image, the image Field Of View (FOV), is determined by how densely the analog Fourier transform is sampled. As the density of the sampling is increased, the FOV of the image increases. For a spatially-limited scene, there is a sampling density at which the image coverage is equal to the support of the scene (determined by the width of the antenna footprint). If the Fourier transform is sampled above this rate, the FOV of the image extends beyond the finite support of the scene, and the result resembles a zero-padded or zero-extended image. By selecting the Fourier domain sampling density such that the FOV of the SAR image extends beyond the brightly illuminated portion of the scene the focused digital image is (effectively) spatially-limited, allowing the use of the autofocus approach of procedure 120.

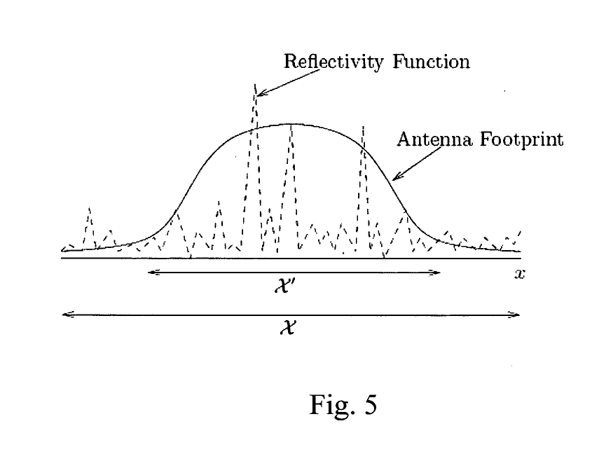

FIG. 5 shows an illustration of the antenna pattern along the x-axis. A length X′ region of the scene is brightly illuminated in the x dimension. To use the MCA approach to autofocus, the image coverage X is set greater than the illuminated region X′. The antenna pattern shown in FIG. 5 is superimposed on the scene reflectivity function for a single range (y) coordinate. The finite beamwidth of the antenna causes the terrain to be illuminated only within a spatially-limited window—the return outside the window is near zero. To model the antenna pattern, consider the case of an unweighted uniformly-radiating antenna aperture. Under this circumstance, both the transmit and receive patterns are described by a sinc function. Thus, the antenna footprint determined by the combined transmit-receive pattern is modeled as set forth in expression (50):

w(x)=sin c²(Wₓ⁻¹x), (50)

where expression (51) applies as follows:

$${W}_{x} = \frac{{λ}_{0} {R}_{0}}{D} , \qquad ( 51 )$$

$$sin c ( x ) {=}^{def} ( sin π x ) / ( π x ) ,$$

x is the cross-range coordinate, λ₀ is the wavelength of the radar, R₀ is the range from the radar platform to the center of the scene, and D is the length of the antenna aperture. Near the nulls of the antenna pattern at x=±Wₓ, the attenuation will be very large, producing low-return rows in the focused SAR image consistent with expression (29). Using the model in expression (50), the Fourier-domain sampling density should be large enough so that the FOV of the SAR image is equal to or greater than the width of the main lobe of the sinc window: X≧2 Wₓ. In spotlight-mode SAR, the Fourier-domain sampling density in the cross-range dimension is determined by the pulse repetition frequency (PRF) of the radar. For a radar platform moving with constant velocity, increasing the PRF decreases the angular interval between pulses (i.e., the angular increment between successive look angles), thus increasing the cross-range Fourier-domain sampling density and FOV. Alternatively, keeping the PRF constant and decreasing the platform velocity also increases the cross-range Fourier-domain sampling density—which results in airborne SAR when the aircraft is flying into a headwind. In many cases, the platform velocity and PRF are such that the image FOV is approximately equal to the main lobe width defined by expression (50). In such case, the final images are typically cropped to half the main lobe width of the sinc window because it is realized that the edge of the processed image will suffer from some amount of aliasing. Per procedure 120, the additional information from the discarded portions of the image can be used for SAR image autofocus.

Another instance where the image support assumption can be exploited is when prior knowledge of low-return features in the SAR image is available. Examples of such features include smooth bodies of water, roads, and shadowy regions. If the image defocusing is not very severe, then low-return regions can be estimated using the defocused image. Inverse SAR (ISAR) provides a further application for MCA. In ISAR images, pixels outside of the support of the imaged object (e.g., aircraft, satellites) correspond to a region of zero return. Thus, given an estimate of the object support, MCA can be applied.

### Experimental Examples

The following experimental examples are provided for illustrative purposes and are not intended to limit scope of the inventions of the present application or otherwise be restrictive in character.

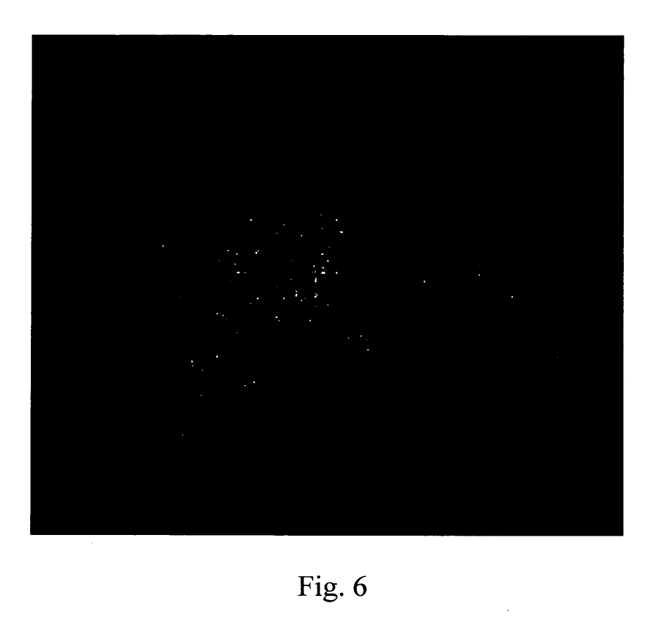

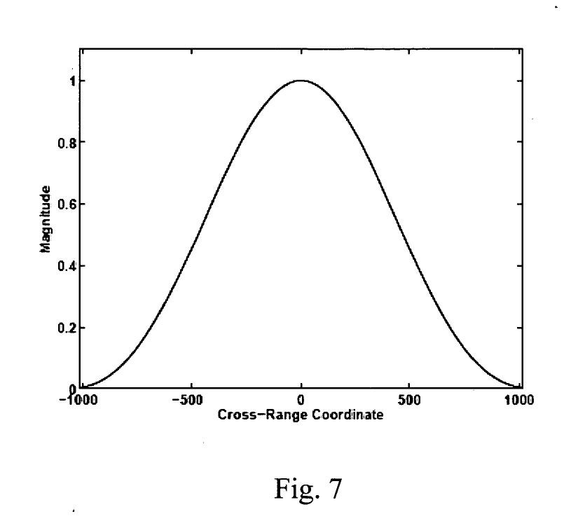

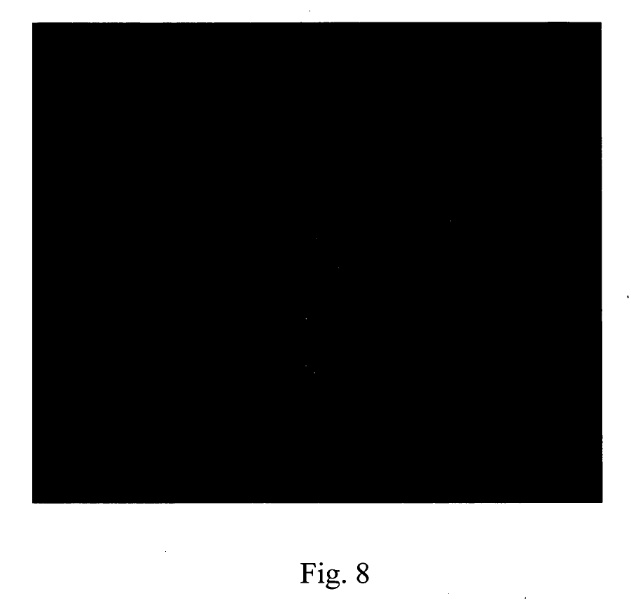

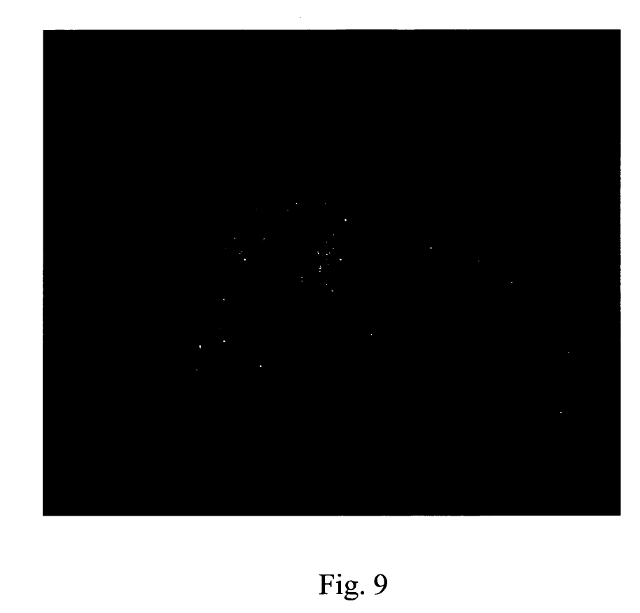

FIGS. 6-9 correspond to an experiment using an actual SAR image. To form a ground truth focused image, an entropy-minimization autofocus routine was applied to the given SAR image. FIG. 6 shows the resulting image, where the sinc-squared antenna footprint window of FIG. 7 was applied to each column to simulate the antenna footprint resulting from an unweighted antenna aperture. The cross-range FOV equals 95 percent of the main lobe width of the squared-sinc function, i.e., the image is cropped within the nulls of the antenna footprint, so that there is very large (but not infinite) attenuation at the edges of the image. FIG. 8 shows a defocused image produced by applying a white phase error function (i.e., independent phase components uniformly distributed between −π and π) to the focused image in FIG. 6. Applying procedure 120 to the defocused image and assuming the top and bottom rows of the perfectly-focused image to be low-return, the resulting MCA restoration is displayed in FIG. 9, which was observed to be in good agreement with the ground truth image. To quantitatively assess the performance of autofocus techniques, a restoration quality metric SNRₒᵤₜ (i.e., output signal-to-noise ratio) was used defined as:

$${SNR}_{out} = 20 {log}_{10} \frac{{‖ vec \{ g \} ‖}_{2}}{{‖ ( \vert vec \{ g \} \vert - \vert vec \{ \hat{g} \} \vert ) ‖}_{2}} ;$$

where: the “noise” in SNRₒᵤₜ refers to the error in the magnitude of the reconstructed image ̂g relative to the perfectly-focused image g, and should not be confused with additive noise (which is considered later). For the restoration in FIG. 9, SNRₒᵤₜ=10.52 dB.

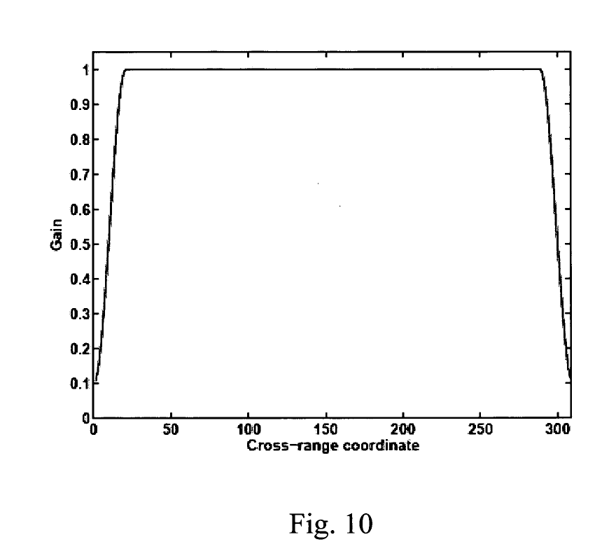

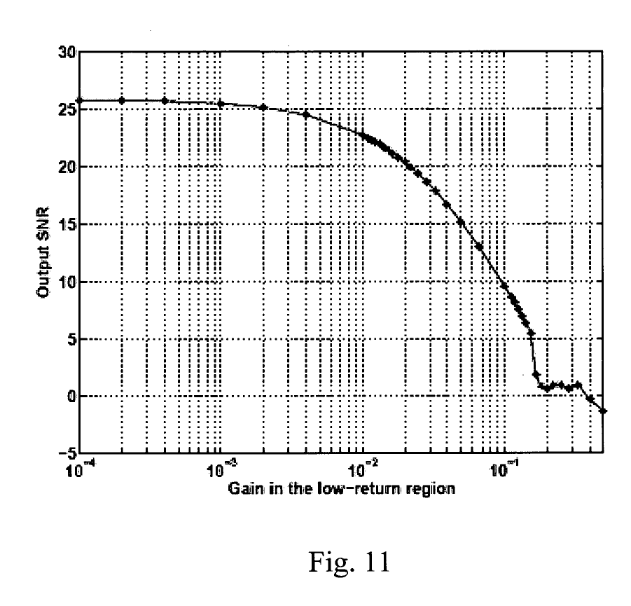

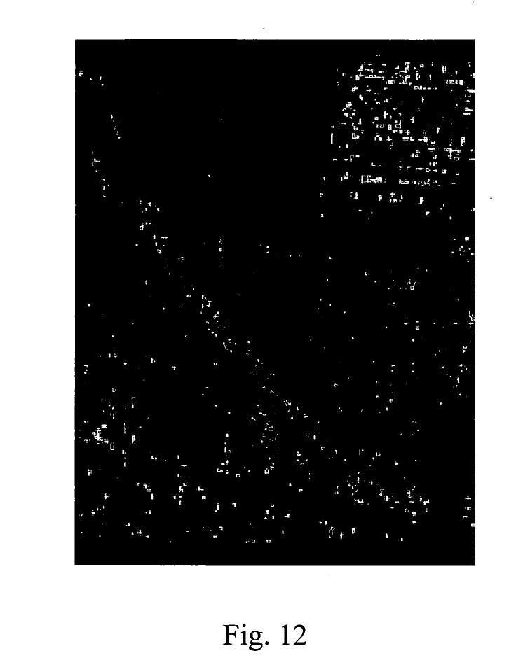

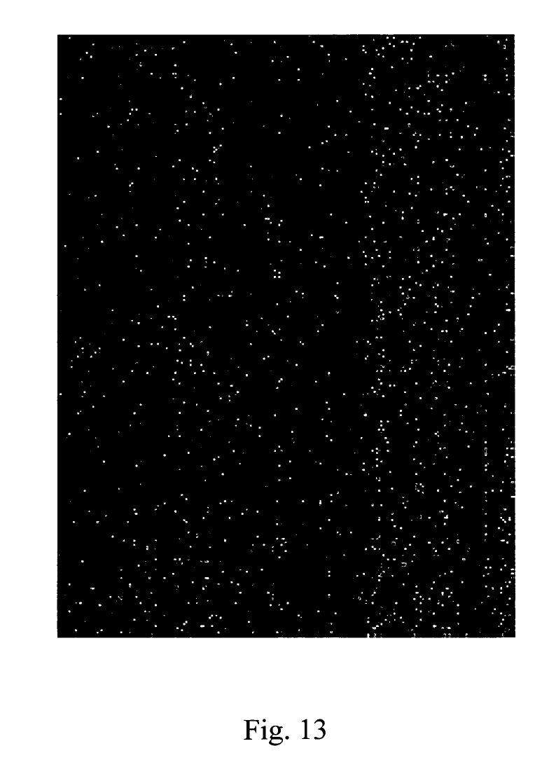

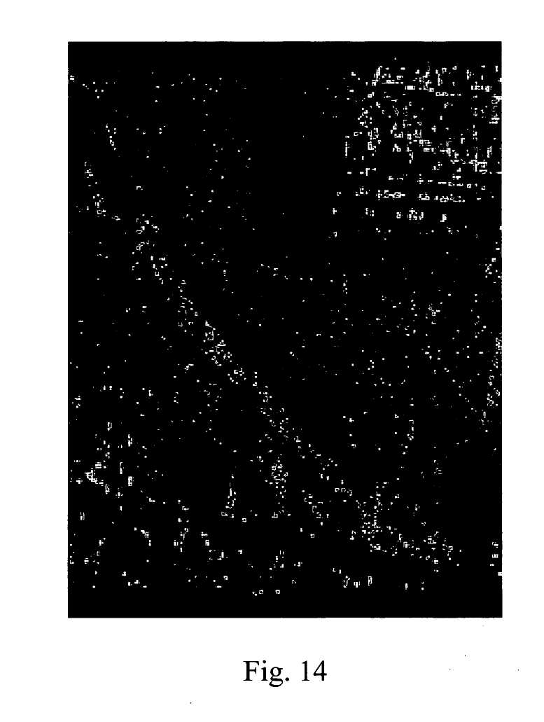

To evaluate the robustness of the procedure 120 approach with respect to the low-return assumption, a series of experiments were performed using the idealized window function depicted in FIG. 10. This window has a flat response over most of the image. The tapering at the edges of the window is described by a quarter-period of a sine function. In each experiment, the gain at the edges of the window (i.e., the inverse of the attenuation) is increased such that the pixel magnitudes in the low-return region (corresponding to the top and bottom rows) become larger. In FIG. 10, a window gain of 0.1 is shown. For each value of the window gain, a defocused image is formed and the MCA restoration is produced. FIG. 11 shows a plot of the restoration quality metric SNRₒᵤₜ versus the gain at the edges of the window, where the top two rows and bottom two rows are assumed to be low-return. The simulated SAR image in FIG. 12 was used as the ground truth perfectly-focused image in this set of experiments. In this case, a processed SAR image is used as a model for the image magnitude, while the phase of each pixel is selected at random (uniformly distributed between −π and π and uncorrelated) to simulate the complex reflectivity associated with high frequency SAR images of terrain. The plot in FIG. 11 demonstrates that the restoration quality decreases monotonically as a function of increasing window gain. It was observed that for values of SNRₒᵤₜ less than 3 dB, the restored images do not resemble the perfectly-focused image. This transition occurs when gain in the low-return region increases above 0.14. For gain values less than or equal to 0.14, the restorations are faithful representations of the perfectly-focused image. Thus, procedure 120 is robust over a large range of attenuation values, even when there is significant deviation from the ideal zero-magnitude pixel assumption. As an example, the image restoration in FIG. 14 corresponds to an experiment where the window gain is 0.1. FIGS. 12 and 13 show the perfectly-focused and defocused images, respectively, associated with this restoration. The image in FIG. 14 is almost perfectly restored, with SNRₒᵤₜ=9.583 dB.

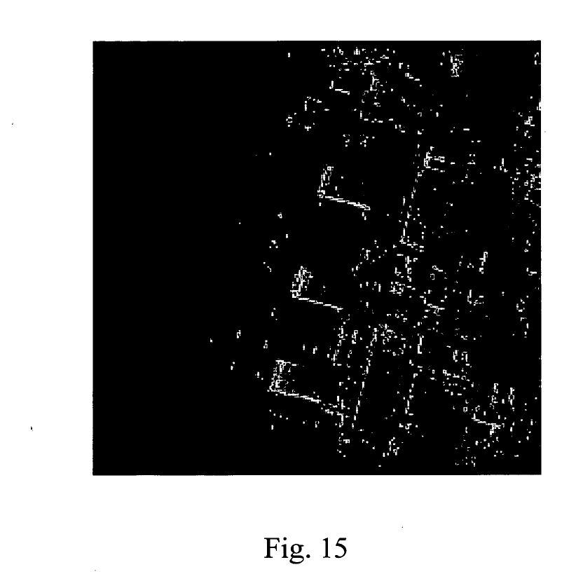

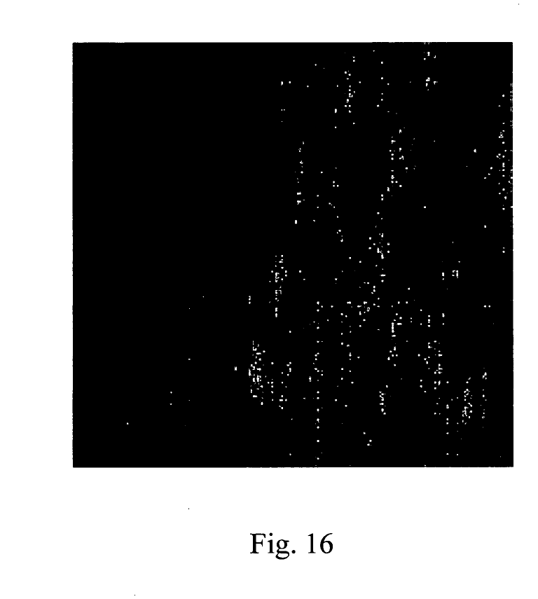

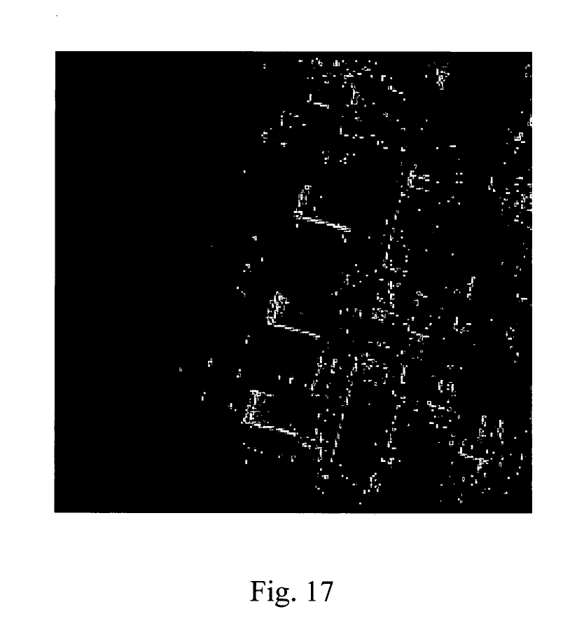

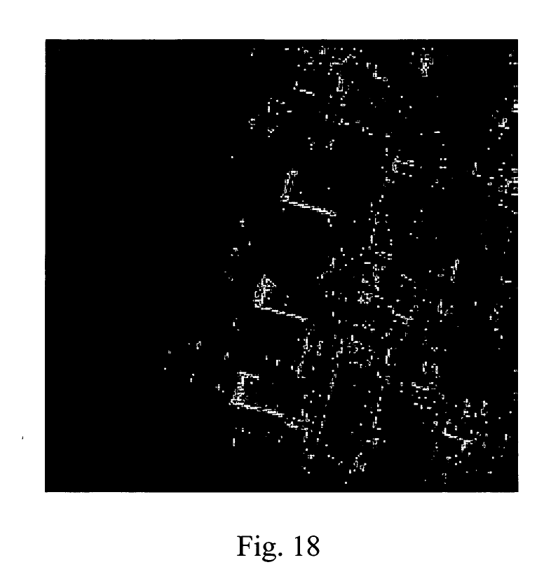

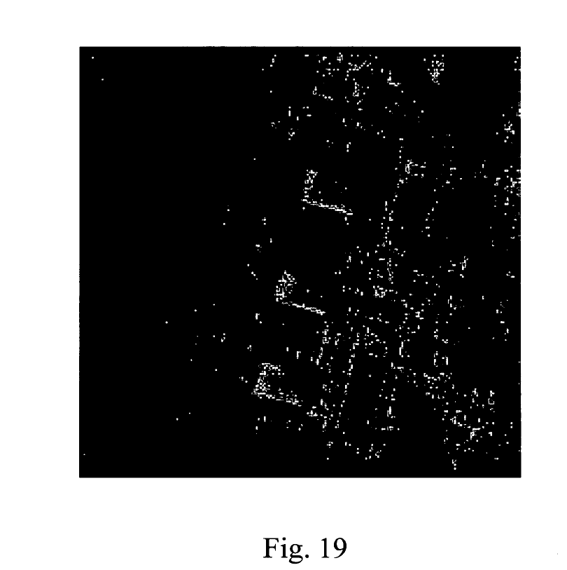

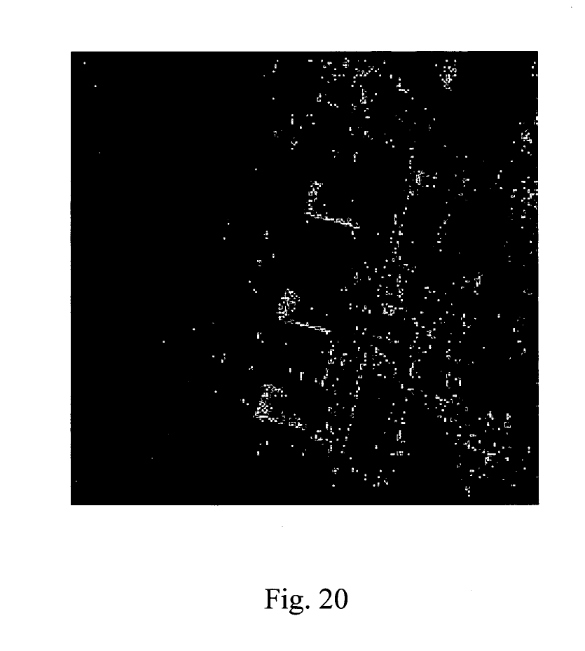

FIGS. 15-20 are provided to compare performance of procedure 120 with standard autofocus approaches. FIG. 15 shows a perfectly-focused simulated SAR image, constructed in the same manner as FIG. 12, where the window function in FIG. 11 has been applied (the window gain is 1×10−4 in this experiment). A defocused image formed by applying a quadratic phase error function (i.e., the phase error function varies as a quadratic function of the cross-range frequencies) is displayed in FIG. 16; such a function is used to model phase errors due to platform motion. The defocused image has been contaminated with additive white complex-Gaussian noise in the range-compressed domain such that the input signal-to-noise ratio (input SNR) is 40 dB; here, the input SNR is defined to be the average per-pulse SNR:

$$SNR = 20 {log}_{10} \{ 1 / M {\sum }_{k} {max}_{n} \tilde{G} [ k , n ] / {σ}_{p} \} ,$$

where: σₚ is the noise standard deviation. FIG. 17 shows the MCA restoration per procedure 120 formed assuming the top two and bottom two rows to be low-return. The image is observed to be well-restored, with SNRₒᵤₜ=25.25 dB. To facilitate a meaningful comparison with the perfectly-focused image, the restorations are produced by applying the phase error estimate to the noiseless defocused image. In other words, the phase estimate is determined in the presence of noise, but SNRₒᵤₜ is computed with the noise removed. A restoration produced using PGA is displayed in FIG. 18 (SNRₒᵤₜ=9.64 dB). FIGS. 19 and 20 show the result of applying a metric-based autofocus technique using the entropy sharpness metric (SNRₒᵤₜ=3.60 dB) and the intensity-squared sharpness metric (SNRₒᵤₜ=3.41 dB), respectively. Of the four autofocus approaches, MCA is found to produce the highest quality restoration in terms of both qualitative comparison and the quality metric SNRₒᵤₜ. In particular, the metric-based restorations, while macroscopically similar to the MCA and PGA restorations, have much lower SNR because they tend to incorrectly accentuate some of the point scatterers.

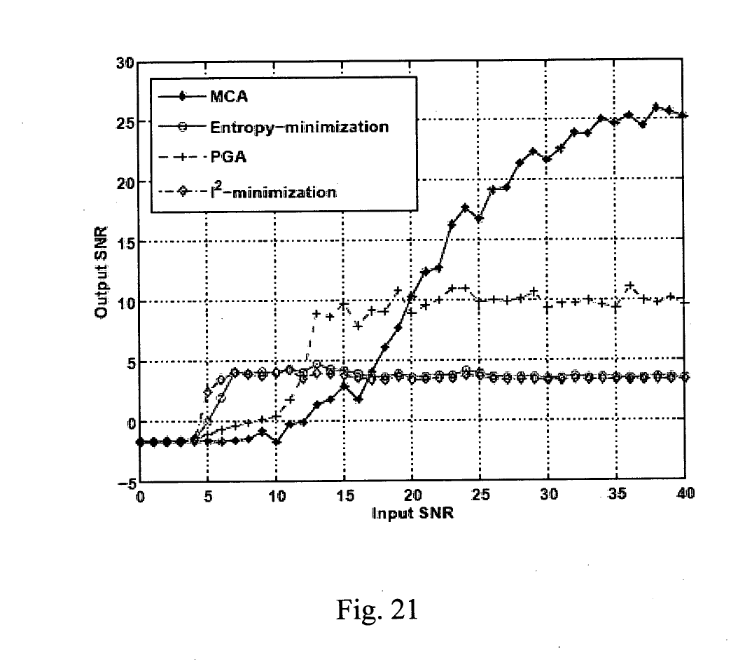

FIG. 21 presents the results of a Monte Carlo simulation comparing the performance of procedure 120 with other autofocus approaches under varying levels of additive noise. In this experiment, the MCA restoration technique of procedure 120 was applied to noisy versions of the defocused image in FIG. 16. Ten trials were conducted at each input SNR level in which a noisy defocused image (using a deterministic quadratic phase error function) was formed using different randomly-generated noise realizations with the same statistics. Four autofocus approaches (MCA restoration, PGA, entropy-minimization, and intensity-squared minimization) were applied to each defocused image, and the quality metric SNRₒᵤₜ was evaluated on the resulting restorations. Plots of the average SNRₒᵤₜ (over the ten trials) versus the input SNR are displayed in FIG. 21 for the four autofocus methods. The plot shows that at high input SNR (SNR≧20 dB), the MCA restoration provides the best performance. Likewise, it was observed that the MCA restored images start to resemble the perfectly-focused image at 13 dB. On average, the MCA restorations in the experiment of FIG. 21 required 3.85 s of computation time, where the algorithm was implemented using MATLAB on an Intel Pentium 4 CPU (2.66 GHz). In comparison, PGA, the intensity-squared approach, and the entropy approach had average run-times of 5.34 s, 18.1 s, and 87.6 s, respectively. Thus, the MCA restoration of procedure 120 was observed to be computationally efficient in comparison with other SAR autofocus schemes.

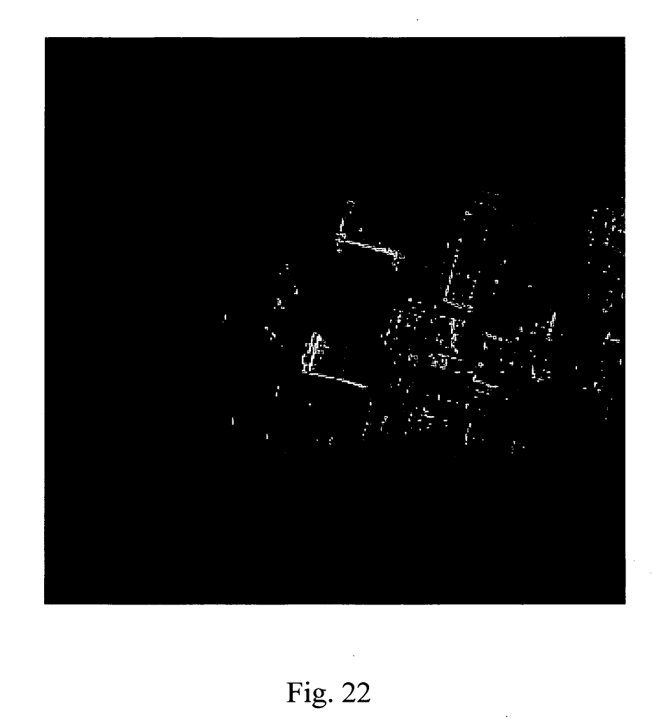

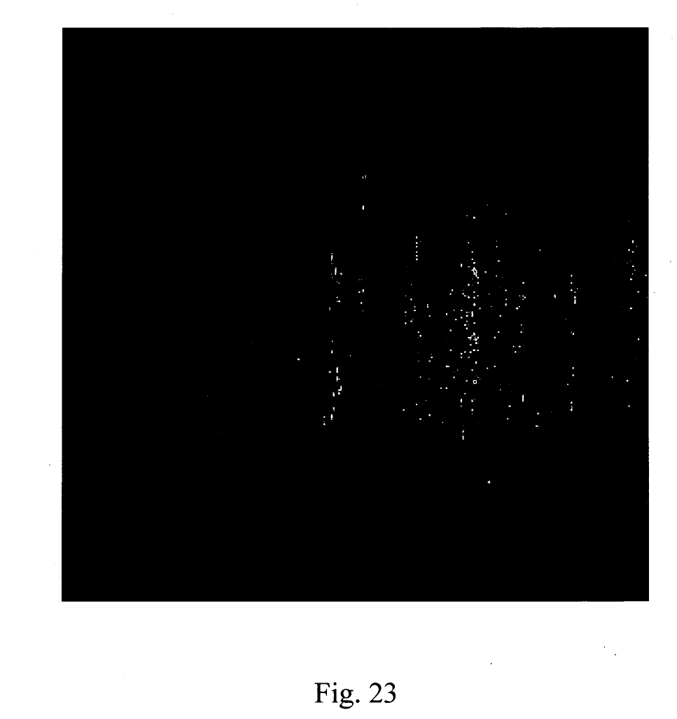

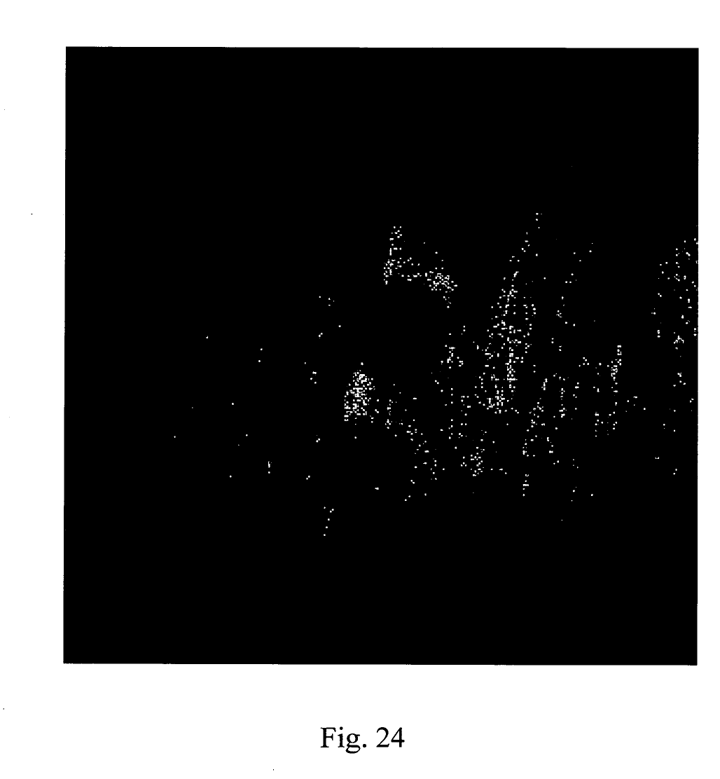

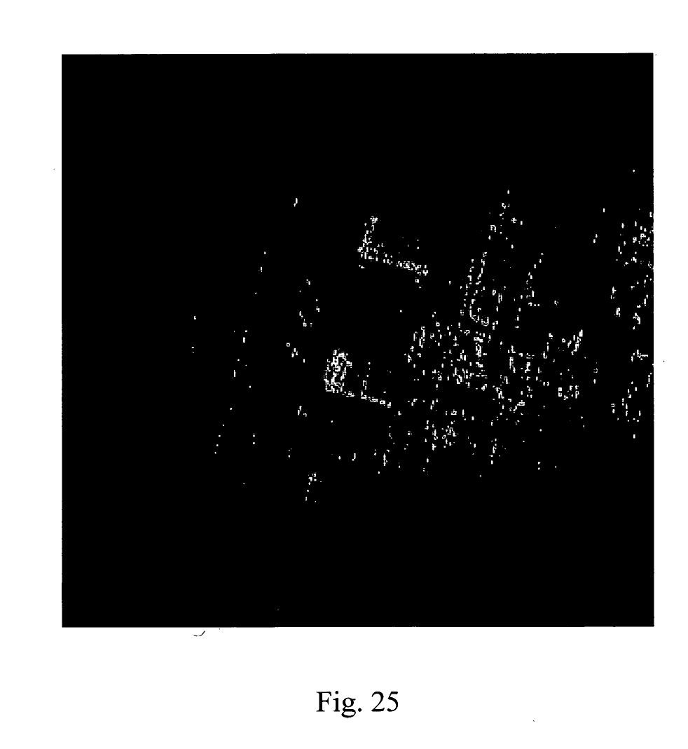

FIGS. 22-25 relate to an experiment using a sinc-squared antenna pattern, where a significant amount of additive noise has been applied to the defocused image. The perfectly-focused and defocused images are displayed in FIGS. 22 and 23, respectively, where the input SNR of the defocused image is 19 dB. Due to the gradual tapering of the sinc-squared antenna pattern, the smallest singular values of the MCA restoration matrix are distributed closely together. As a result, the problem becomes poorly conditioned in the sense that small perturbations to the defocused image can produce large perturbations to the least squares solution of expression (20). In such cases, regularization can be used to improve the solution. FIG. 24 shows the MCA restoration where a large number of low-return constraints (45 low-return rows at the top and bottom of the image) are enforced to improve the solution in the presence of noise. In this restoration, much of the defocusing has been corrected, revealing the structure of the underlying image. However, residual blurring remains. FIG. 25 shows the result of applying the regularization procedure, in which a subspace of 15 basis functions was formed using the minimum right singular vectors of the MCA matrix where the data consistency relation of expression (42) is satisfied. The optimal basis coefficients, corresponding to a unique solution within this subspace, are determined by minimizing the entropy metric. The regularized restoration is shown in FIG. 25. The incorporation of the entropy-based sharpness optimization is found to significantly improve the quality of the restoration, producing a result that agrees well with the perfectly-focused image. Thus, by exploiting the linear algebraic structure of the SAR autofocus problem and the low-return constraints in the perfectly-focused image, the dimension of the optimization space in metric-based methods can be greatly reduced (from 341 to 15 parameters in this example).

Many other embodiments of the present application are envisioned. For example, in one embodiment, a technique includes: acquiring synthetic aperture radar data representative of a defocused form of an image, designating an image region as having a selected radar return characteristic, determining a focus operator as a function of the image region and a data subspace including a restored form of the image, and applying the focus operator to the data to generate information representative of the restored form of the image.

In another example, the embodiment includes a synthetic aperture radar interrogation platform comprising: means for traveling above ground, means for acquiring synthetic aperture radar data representative of a defocused form of an image, means for designating an image region as having a selected radar return characteristic, means for determining a focus operator as a function of the image region and a data subspace including a restored form of the image, and means for applying the focus operator to the data to generate information representative of the restored form of the image.

In still another example, a further embodiment of the present application includes: processing synthetic aperture radar data representative of a defocused image, defining an image processing constraint corresponding to an image region expected to have a low radar return, and focusing the defocused image as a function of the image processing constraint and the data.

A further example comprises: a synthetic aperture radar processing device including means for processing synthetic aperture radar data representative of a defocused image, means for defining an image processing constraint corresponding to an image region expected to have a low radar return, and means for focusing the defocused image as a function of the image processing constraint and the data.

Another example is directed to: a device carrying processor-executable operating logic to process synthetic aperture radar data representative of a defocused image that includes defining an image support constraint corresponding to an image region expected to have a low radar return and focusing the defocused image as a function of the image support constraint and a subspace including a focused form of the defocused image.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only selected embodiments have been shown and described and that all changes, modifications and equivalents that come within the spirit of the invention as defined herein or by any of the following claims are desired to be protected.

What is claimed is:

1. A method, comprising:
acquiring synthetic aperture radar data representative of a defocused form of an image;
designating an image region based on an expected radar return characteristic;
determining a focus operator from the data representative of the image region and a data subspace including a restored form of the image; and
applying the focus operator to the data to generate information representative of the restored form of the image.

2. The method of claim 1, wherein the selected radar return characteristic corresponds to a low radar return relative to a different part of the image.

3. The method of claim 2, wherein the low radar return is approximately zero.

4. The method of claim 2, wherein the image region corresponds to low return image rows.

5. The method of claim 1, which includes applying a sharpness metric.

6. The method of claims 1, wherein the determining of the focus operator includes performing singular value decomposition.

7. A method, comprising:
processing synthetic aperture radar data representative of a defocused image with a processing device;
providing an image processing constraint corresponding to a region of the image expected to have a lower radar return than a different region of the image; and
focusing the defocused image as a function of the image processing constraint and the data.

8. The method of claim 7, which includes generating the synthetic aperture data by oversampling a target.

9. The method of claim 7, wherein the focusing of the defocused image includes performing singular value decomposition.

10. The method of claim 7, wherein the image region has a radar return level of approximately zero.

11. The method of claim 7, which includes performing an adjustment based on a sharpness metric.

12. The method of claim 7, wherein the image region corresponds to a number of image border rows.

13. The method of claim 7, which includes acquiring the synthetic aperture radar data with an aircraft carrying a synthetic aperture radar system.

14. The method of claim 7, which includes characterizing a focused form of the defocused image with a subspace defined by the synthetic aperture radar data.

15. An apparatus, comprising: a device carrying processor-executable operating logic to process synthetic aperture radar data representative of a defocused image that includes an image processing constraint corresponding to a region of the image expected to have a lower radar return than another region of the image and focusing the defocused image as a function of the processing constraint and a subspace including a focused form of the defocused image.

16. The apparatus of claim 15, further comprising a processor and radar transmission and receiving equipment; wherein the device is in the form of a memory storing the operating logic executable by the processor.

17. The apparatus of claim 16, further comprising a radar antenna coupled to the equipment and an aircraft carrying the radar antenna and the equipment.

18. The apparatus of claim 15, wherein the device is in the form of at least a portion of a computer network.

19. An apparatus, comprising: a synthetic aperture radar processing device including:
means for processing synthetic aperture radar data representative of a defocused image;
means for establishing an image processing constraint corresponding to a region of an image expected to have a lower radar return than another region of the image; and
means for focusing the defocused image as a function of the image processing constraint and the data.

20. An apparatus, comprising:
a radar antenna device to acquire synthetic aperture radar data;
radar receiver and transmitter equipment coupled to the radar antenna device; and
a synthetic aperture radar processing device to operatively communicate with the radar receiver and transmitter equipment, the synthetic aperture radar processing device including a processor structured to process the synthetic aperture radar data, the data being representative of a defocused image, the processor being further structured to define an image processing constraint corresponding to a region of the image expected to have a lower radar return than another region of the image and generate one or more output signals as a function of the image processing constraint and the data, the one or more output signals being representative of a more focused form of the defocused image.

21. The apparatus of claim 20, further comprising one or more output devices responsive to the one or more output signals to provide the more focused form of the defocused image.

22. The apparatus of claim 20, further comprising means for moving the antenna and the equipment above ground along a selected track.

23. The apparatus of claim 20, wherein the processor includes means for performing the processing in accordance with a sharpness image metric.

24. The apparatus of claim 20, further comprising an aircraft carrying the antenna device, the equipment, and the synthetic aperture radar processing device.
